(19) United States
(12) Patent Application Publication
(10) Pub. No.: US 2008/0032253 A1
(43) Pub. Date: Feb. 7, 2008

(54) Device and method for improving oral health

(76) Inventors: R. Eric Montgomery, Monterey, MA (US); Kenneth Rosenblood, Los Angeles, CA (US); Christpher Quan, North Hills, CA (US)

Correspondence Address: DISCUS DENTAL IMPRESSIONS, INC., 8550 HIGUERA STREET, CULVER CITY, CA, 90232, US

(21) Appl. No.: 11/818,743

(22) Filed: Jun. 15, 2007

Related U.S. Application Data
(63) Continuation-in-part of application No. 11/344,974, filed on Feb. 1, 2006.
(60) Provisional application No. 60/814,239, filed on Jun. 15, 2006.
(60) Provisional application No. 60/892,859, filed on Mar. 4, 2007.
(60) Provisional application No. 60/649,402, filed on Feb. 2, 2005.

(51) Int. Cl. A61C 19/06

(52) U.S. Cl. 433/29; 433/217.1; 433/97

(57) ABSTRACT

The present invention relates to a method for improving the oral health of a subject by exposing the oral cavity of the subject to a device comprising a light source that emits a therapeutically effective amount of light. The present invention further relates to devices utilized in exposing light to the oral cavity of a subject in the method of the present invention.

### CROSS-REFERENCE TO RELATED CASES

This application claims the benefit of U.S. provisional patent applications: Ser. No. 60/814,239, entitled “Method and Device for Improving Oral Health” filed on Jun. 15, 2006; and Ser. No. 60/892,859, entitled “Device and Method for Improving Oral Health” filed Mar. 4, 2007; and is a continuation-in-part of U.S. Ser. No. 11/344,974, filed Feb. 1, 2006, which claims priority to U.S. Provisional application No. 60/649,402 entitled, “Method and Device for Improving Oral Health” filed Feb. 2, 2005; the contents of all are hereby incorporated by reference.

### FIELD OF THE INVENTION

The present invention relates to methods and devices for improving the health of the oral cavity of a subject.

### BACKGROUND OF THE INVENTION

Periodontal (gum) diseases affect 80 to 90% of adults and are a major cause of tooth loss in the Western world now that caries (tooth decay) incidence is in decline. They occur with increased frequency in patients with Down's syndrome and with systemic diseases such as diabetes mellitus, AIDS, leukemia, neutropenia, and Crohn's disease. Many bacteria live in the oral cavity. Some investigators have suggested that as many as 600 species may be identified. The panel of organisms living in the oral cavity include, but are not limited to, periodontal pathogens (P. gingivalis, T. forsythensis, T. denticola, and A. actinomycetemcomitans), bacteria thought to be pre-pathogenic (e.g., P. nigrescens, F. periodonticum and other Fusobacterium, C. rectus, Eubacterium sp., P. micros, E. corrodens, and Selenomonas noxia), bacteria thought to be beneficial (e.g., A. naeslundii and other Actinomycetes, S. sanguis and other Streptoccocci) and bacteria principally associated with gingivitis (e.g., V. parvula). The Gram negative, black-pigmenting anaerobes of the genera Prevotella and Porphyromonas are important pathogens associated with these conditions. Porphyromonas gingivalis is a Gram-negative black-pigmenting anaerobe that is most strongly associated with progressive periodontal (gum) disease in adults. The standard battery of 40 periodontal bacteria are included in Table 1.

TABLE 1

| | | |
|---|---|---|
| Actinomyces naes- | Streprococcus anginosus | Neisseria mucosa |
| lundii 1 | | |
| Streptococcus constell- | Streptococcus sanguis | Fusobacterium nucle- |
| atus | | atum ss nucleatum |
| Eubacterium nodatum | Actinomyces gerenc- | Capnocytophaga ging- |
| | seriae | ivalis |
| Prophyromonas ging- | Streptococcus oralis | Strptococcus gordonii |
| ivalis | | |
| Actinobacillus | Capnocytophaga | Taneralla forsythensis |
| actinomycetemcom- | ochracea | |
| itans (serotypes a & b) | | |
| Fusobacterium nucle- | Actinomyces israelii | Selenomonas noxia |
| atum ss vincentii | | |
| Campylobacter rectus | Streptococcus inter- | Propionibacterium |
| | medius | acnes (serotypes I & |
| | | II) |
| Treponema socranskii | Treponema denticola | Prevotella melano- |
| | | genica |
| Eubacterium sab- | Prevotella nigrescens | Streptococcus mitis |
| urreum | | |
| Peptostreptococcus | Actinomyces odontolyt- | Eikenella corrodens |
| micros | icus (serotype I) | |
| Veillonella parvula | Fusobacterium nucle- | Gemella morbillorum |
| | atum ss polymorphum | |
| Actinomyces naes- | Camplylobacter showae | Capnocytophaga sputi- |
| lundii 2 (A. viscosus) | | gena |
| Campylobacter | Fusobacterium period- | Leptotrichia buccalis |
| gracillis | onticum | |
| Prevotella intermedia | | |

Conventionally, prevention and control of the periodontal diseases is by home care, which is directed to remove or to modify bacterial plaque. This generally includes tooth brushing, toothpaste, antibacterial mouth rinses, and interperoximal cleaning aids, such as floss, toothpicks, interproximal stimulators and interproximal brushes. When regularly applied, these methods reduce the mass of bacterial plaque. However, these methods do not affect the composition or species distribution of the bacterial plaque. Further, these methods are painful, abrasive, burdensome, and the effects that they produce are often short-lived.

Thus, there is a need for a therapy that affects the composition of the bacterial plaque and reduces their pathogenic potential. There is also a need for a painless, abrasion-free, easy-to-apply periodontal therapy that produces a sustained effect for a longer period of time following a single or multiple in-office or take-home treatments.

### SUMMARY OF THE INVENTION

The present invention provides a device and method for improving the health of the oral cavity. More particularly, the present invention relates to a device and method of improving the oral health of a subject by exposing a portion of the oral cavity of the subject to light for therapeutic effects and optionally a therapeutic agent such as an oxidizing, an antimicrobial agent, or other auxiliary agent to selectively eliminate or reduce bacteria from the oral cavity of a subject.

One aspect of the present invention relates to a device and method of reducing gingivitis in the subject by exposing the oral cavity of the subject to a light source for a predetermined period of time.

Another aspect of the present invention relates to a device and method of whitening teeth in the subject by exposing the oral cavity of the subject to a whitening agent and light source for a predetermined period of time.

A further aspect of the present invention relates to a device and method for treating teeth or tissue of the subject by exposing the oral cavity of the subject to a therapeutic agent and light source for a predetermined period of time.

The devices of the present invention are utilized in directing light to the oral cavity of a subject in the method of the present invention. In one aspect, at least one light source may be embedded within a device that fits within the oral cavity. In general, the device is adapted to fit at least around the arches and in particular the teeth of a user. In one embodiment, the device is in the form of a dental tray. The tray may in general include a channel that substantially covers and retains the teeth of an arch. The tray may also include a second channel such that the tray may cover and retain the teeth of both the upper and lower arches. The tray may also be configured to contain therapeutic agents that may be activated by the light to aid in the treatment. At the same time, non-light activatbale therapeutic agents including some vitamins and/or other dietary aids may also be administered. In this manner, multiple therapeutic actions may be administered at once to save time.

In another embodiment, the device may be in the form of a strip that may be shaped and/or formed to contour to the arches and/or teeth of a user, similar to a dental tray or a dental impression tray.

In general, the device may be constructed from a transparent, translucent or otherwise light-permeable/carrying material. The material may be flexible or substantially rigid. In some embodiments, the material may be a light-permeable polymeric material, which may include, but is not limited to, polypropylene, polyethylene, polystyrene, polycarbonate, polylactic acid (PLA), polyacetal, fluoropolymers, such as polyvinylidene fluoride (PVDF) and fluorinated ethylene-propylene (FEP), polymethyl methacrylate (acrylic), silicone plastic, and/or any other appropriate polymeric material.

In one embodiment, light may be directed to the entire oral cavity from the light source or sources. In another embodiment, light may be directed to a portion of the oral cavity to be treated, by contact of the portion of the cavity to be treated with at least a portion of the device. In a further embodiment, louvers may be employed on the surfaces of the device to direct light onto specific portions or away from specific portions of the oral cavity.

In one aspect, the device may include at least one light source that emits at least one wavelength. The emitted light is in general of a wavelength and intensity that is useful for therapeutic action in the oral cavity and the light source is generally disposed within or on the device to effectively and efficiently deliver light to the target surface(s) in the oral cavity. In some aspects, the device may include multiple light sources which may be distributed within or on the surface of the device.

In some embodiments, the device may include electroluminescent materials including light emitting diodes, or organic or polymer light emitting diode materials (OLEDs or PLEDS). OLEDs may in general be formed from layers of appropriate materials which may emit light from a junction in response to an applied electric current. In one embodiment, the device may include OLED layers within its structure. The OLED layers may have similar dimensions to the device or the layers may be smaller than the dimensions of the device. In some embodiments, the multiple OLEDs may be utilized and may be arranged for effective and efficient light delivery to the target surfaces of the oral cavity.

In other embodiments, the device may include other types of light generation, which may include, but are not limited to, light emitting chemicals and/or reactions (fluorescent, phosphorescent, chemiluminescent), incandescent light sources, capacitive release light sources, and/or any other appropriate light source.

In another aspect, the device may include a light gating layer. The gating layer may be opaque. The opaque gating layer may be a flexible polymer or elastomer such as an ethylene vinyl acetate copolymer or styrene-butadiene-styrene block copolymer with dispersed light-blocking agents or fillers, such as titanium dioxide or zinc oxide. Alternatively, the opaque gating layer may be a liquid or gel such as a silicone fluid with dispersed light blocking agents or fillers encased in a leak proof flexible outer casing that is integrally attached an underlying-layer. The gating layer may only allow light through sufficient pressure is exerted to thin the gating layer to render it transparent or translucent.

In one embodiment, the gating layer may be used in combination with a rigid layer or part of the dental tray. Rigid, for the purposes of this invention, means less flexible than the flexible gating opaque layer, if any, described above. The rigid layer or plate is of sufficient harshness and structural integrity to maintain its original shape until placed into the oral cavity for molding about the teeth. In general, and when there is an inner and an outer, separate opaque gating layer, the inner layer tends to be more rigid than the outer layer or layers. The inner layer generally includes light sources or may be a light emitting layer. This allows for the compression of the outer layer to cause the necessary thinning of this layer for gating the light, and the inner layer is rigid enough to resist said thinning pressure.

In some aspects, the device may include electrical circuitry to control and provide power for the light source(s). In some embodiments, a power source may deliver electrical energy to the light sources via wires embedded in the material of the device. In other embodiments, the device may include conductive materials, which may be disposed to carry electrical energy to the light sources from a power source.

In some embodiments, the power source may be a battery, which may be embedded or otherwise retained within the device structure. In other embodiments, the power source may be any transducer.

The power source may be located inside or outside the oral cavity during use.

In one embodiment, a transducer may include a material or component that may convert a supplied form of energy into electrical energy. For example, a transducer may include a piezoelectric material, which may convert mechanical energy, such as from compression, vibration and/or other mechanical deformation, to electrical energy. Piezoelectric materials may include, but are not limited to, polymers such as PVDF, crystals such as quartz, or a Rochelle salt crystal, piezoelectric ceramics, such as a lead-zirconate-titanate (PZT) ceramic, and/or any other appropriate piezoelectric materials. In general, a piezoelectric material may be selected that may effectively and efficiently harness an available source of mechanical energy. In one embodiment, mechanical energy may be supplied by the bite force or mastication of a user.

A transducer may also utilize a pyroelectric material, which may generate electrical energy in response to a temperature change. For example, a pyroelectric material may absorb thermal energy from the environment, such as from the body heat of a user to generate electrical energy. The pyroelectric material may also be heated separately before use. Some pyroelectric materials may also generate electric energy in response to cooling. Pyroelectric materials may include, but are not limited to, polymers such as PVDF and polyvinyl fluoride (PVF), gallium nitride (GaN), lithium tantalate, and/or any other appropriate pyroelectric material. In general, a pyroelectric material may be selected that may effectively and efficiently harness an available source of temperature change, such as the difference between ambient temperature and the oral cavity of a user.

In still another aspect, the device may be used with conjunction with chemical agents. Light-activated chemical compositions may be utilized to enhance therapeutic effects and/or utilize light energy to produce a therapeutic effect. In one embodiment, a chemical agent that increases the susceptibility of oral microbes to light may be used. In another embodiment, a light-activated teeth whitening composition may be used. Teeth whitening compositions may include an oxidizing agent, such as hydrogen peroxide and/or carbamide peroxide, and a photoinitiator. Teeth whitening compositions may also include other agents such as flavorants, stabilizers, desensitizing agents, remineralizing agents, and/or any other appropriate agents.

In some embodiments, a device may include at least one coating of a therapeutic chemical composition. The coating may be a composition that includes a water soluble carrier in which at least one chemical agent may be dispersed. The water soluble carrier may be, for example, a soluble polymeric material. Such materials include, but are not limited to, hydrophilic materials including polysaccharides such as carrageenan, chondroitin sulfate, glucosamine, pullulan, soluble cellulose derivatives such as hydroxypropyl cellulose and hydroxymethyl cellulose, polyacrylic acid, polyvinyl alcohol, polyethylene glycol (PEG), polyethylene oxide (PEO), ethylene oxide-propylene oxide co-polymer, polyvinylpyrrolidone (PVP) and/or any other appropriate material.

In an exemplary embodiment, the water soluble carrier included is pullulan. Pullulan is a soluble polysaccharide polymer derived from a fungal organism composed of triose sugar units. Pullulan coatings may be a self adherent, flexible and/or relatively high strength film that may resiliently remain on the applied surface(s) and that dissolves very quickly on contact with a wet or moist environment. They are also useful in encapsulating other materials, as pullulan has oxygen barrier properties and is thus further useful for preserving the encapsulated material(s).

The coating may cover any desired portion of the device. In general, the coating may cover at least a portion that may be in contact with the teeth or oral tissues when in use.

In some embodiments, the device may include coatings disposed in patterns on its surface. The coatings may be formed to give visual appeal to the user, such as by introducing particular patterns. Patterns may include, for example, stripes, spots, checkerboards, floral designs, pictures, and/or any other appropriate pattern.

In an exemplary embodiment, multiple separated coatings may be used to contain therapeutic agents that may be kept separate prior to use. For example, a set of coating stripes, spots or other shape may contain parts of a remineralizing composition, such as an amorphous calcium phosphate (ACP) or amorphous strontium phosphate composition. One set of coatings may contain a calcium source, such as calcium nitrate, and another set of coatings may contain a phosphate source, such as sodium phosphate. The composition may then be formed when the coatings dissolve due to oral cavity moisture and release the components of the composition to combine. In this manner, multiple therapeutic actions may be administered at once to save time, as noted above.

In one embodiment, the dental tray may be used for whitening and a one component whitening composition may be introduced to the tray already including separate sets of coatings of components of amorphous calcium or strontium phosphate.

Other variations and equivalent structures of the present invention are also contemplated to be within the scope of the present invention.

### BRIEF DESCRIPTION OF THE DRAWINGS

FIG. 1 illustrates a perspective view of a dental device in the form of a tray, according to one embodiment of the present invention;

FIG. 1a illustrates a dental tray with embedded light sources;

FIG. 1b shows the embedded light sources of FIG. 1a;

FIG. 1c illustrates embedded light generating chemical vessels;

FIG. 2 illustrates a perspective view of a dental device in the form of an open ended tray, according to another embodiment of the present invention;

FIG. 2a illustrates a perspective view of a dental device in the form of a double open ended tray, according to an alternative embodiment of the invention;

FIG. 3 illustrates an organic light emitting diode layer arrangement in one embodiment of the present invention;

FIG. 3a shows light emission from an organic light emitting diode layer arrangement;

FIG. 3b illustrates the generation of electric potential across a transducer layer in response to an outside source of energy;

FIG. 3c illustrates an organic light emitting diode layer arrangement with a transducer layer;

FIG. 3d shows a poled arrangement of a polyvinylidene fluoride polymer chain;

FIG. 4 illustrates forming a dental tray with an embedded light emitting source;

FIG. 4a illustrates a light emitting dental device in the form of a flexible strip;

FIGS. 5, 5a, 5b and 5c illustrate light delivery to the teeth and oral tissues from embodiments of light emitting dental devices according to the present invention;

FIGS. 6, 6a, 6b and 6c illustrate embodiments of light emitting dental devices with light gating layers according to the present invention;

FIG. 6d shows an impression-type tray of an embodiment of the present invention;

FIGS. 7, 7a, 7b, 7c and 7d illustrate embodiments of dental devices with coatings according to the present invention.

### DETAILED DESCRIPTION OF THE INVENTION

The detailed description set forth below is intended as a description of the presently exemplified oral care methods and devices provided in accordance with aspects of the present invention and are not intended to represent the only forms in which the present invention may be prepared or utilized. The description sets forth the features and the steps for preparing and using the methods and devices of the present invention. It is to be understood, however, that the same or equivalent functions and components incorporated in the methods and devices may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

As noted above, the present invention provides a device and method for improving the health of the oral cavity. More particularly, the present invention relates to a device and method of improving the oral health of a subject by exposing a portion of the oral cavity of the subject to light and optionally an oxidizing or other auxiliary agent to selectively eliminate or reduce bacteria from the oral cavity of a subject. One aspect of the present invention relates to a method of reducing gingivitis in the subject by exposing the oral cavity of the subject to a light source for a predetermined period of time.

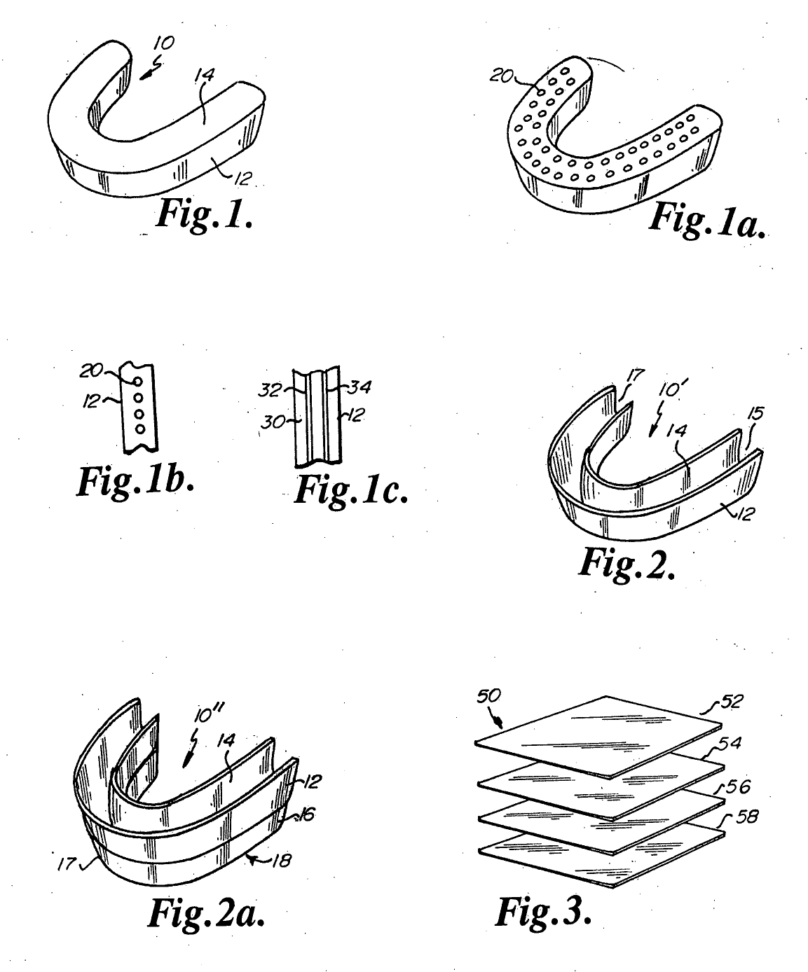

The devices of the present invention are utilized to direct light to the oral cavity of a subject in the method of the present invention. In one aspect, at least one light source is embedded within a device that fits within the oral cavity. In general, the device is adapted to fit around the arches and in particular the teeth of a user. FIG. 1 illustrates an embodiment of a dental device 10, which is in the form of a dental tray. The tray 10 may in general include a channel 14 formed by wall 12 that substantially covers and retains the teeth of an arch. In general, the device 10 may be constructed from a transparent, translucent or otherwise light-permeable/carrying material. The material may be flexible or substantially rigid. In some embodiments, the material may be a light-permeable polymeric material, which may include, but is not limited to, polypropylene, polyethylene, polystyrene, polycarbonate, polylactic acid (PLA), polyacetal, fluoropolymers, such as polyvinylidene fluoride (PVDF) and fluorinated ethylene-propylene (FEP), polymethyl methacrylate (acrylic), silicone plastic, and/or any other appropriate polymeric material.

In other embodiments, the dental device may be in the form of a tray 10′ with open ends 15, 17 to accommodate different arch dimensions, as shown in FIG. 2, a tray 10″ with two channels 14, 18 for retaining both arches, as shown in FIG. 2a, or a flexible strip 70′, as shown in FIG. 4a.

In one aspect, the device 10 may include at least one light source 20, as shown in FIG. 1a, that emits at least one wavelength of light. The emitted light is in general of a wavelength and intensity that is useful for therapeutic action in the oral cavity and the light source is generally disposed within or on the device to effectively and efficiently deliver light to the target surface(s) in the oral cavity. In some embodiments, the at least one light source 20 may be electroluminescent light sources such as light-emitting diodes (LEDs), organic or polymeric light emitting materials, or combinations thereof, which may be distributed on surface of the device 10, or within the wall 12 of the device, as shown in FIG. 1b.

In other embodiments, the light sources 20 may be incandescent light sources, fluorescent light sources, capacitive release light sources, and/or any other appropriate light sources.

In another embodiment, the device 10 may include light emitting compositions. FIG. 1c illustrates the use of chemical-filled vessels 32, 34. The vessels 32, 34 may be contained within the wall 12 of the device 10 and may release their contents into an internal hollow space 30 by, for example, deforming the device 10 to break the vessels 32, 34. The contents of the vessels 32, 34 may be components of a light emitting composition, such as those used in glow sticks.

In an exemplary embodiment, the dental device may include organic or polymer light emitting diode materials (OLEDs or PLEDs). OLEDs may in general be formed from layers of appropriate materials which may emit light from a junction in response to an applied electric current. Some OLED materials, such as PLED materials, may be flexible and may also be deposited by relatively simple operations, such as, for example, inkjet printing, film layer deposition, or other similar coating methods.

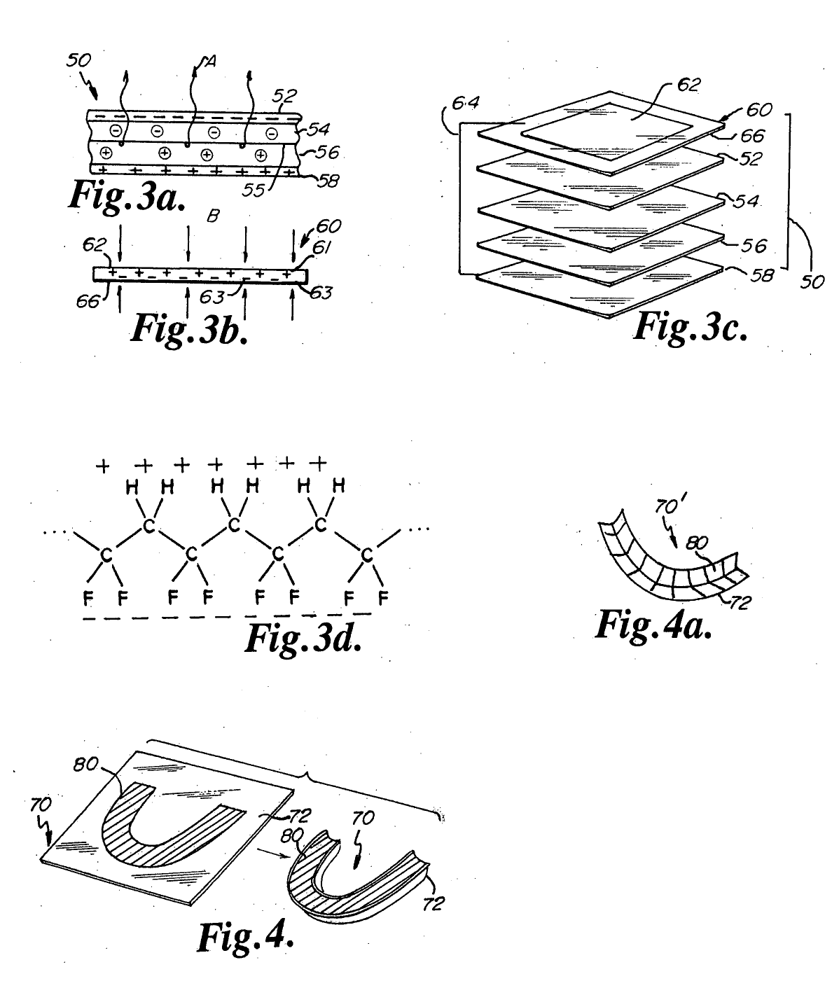

In one embodiment, a dental device may include OLED layers within its structure. FIG. 3 illustrates an OLED layer stack 50. In general, an OLED may include an emissive layer 54 and a conductive layer 56 sandwiched between a cathode 52 and an anode 58. As shown in FIG. 3a, electrons may flow from the cathode 52 to the emissive layer 54, where negative charges interact with positive holes in the conductive layer 54, causing an emission of light A of a particular wavelength, which may depend on the bandgap of the materials. It may be appreciated that the particular stack order and the direction of the emitted light may depend on the nature of the materials used. The materials that light travels through in the OLED stack 50 may in general be transparent or translucent to allow light to escape the stack 50. For example, transparent cathodes 52 may be thin film layers of conductive materials, such as indium tin oxide. The OLED stack 50 may have similar dimensions to the dental device or the stack 50 may be smaller than the dimensions of the device. In some embodiments, the multiple OLEDs may be utilized and may be arranged for effective and efficient light delivery to the target surfaces of the oral cavity.

In some aspects, the device may include electrical circuitry to control and provide power for the light source(s). These power sources may be located inside or outside the oral cavity during use. In some embodiments, a power source may deliver electrical energy to the light sources via wires embedded in the material of the device. In other embodiments, the device may include conductive materials, which may be disposed to carry electrical energy to the light sources from a power source.

In some embodiments, the power source may be a battery, which may be embedded or otherwise retained within the device structure. In other embodiments, the power source may be any transducer.

In one embodiment, a transducer may include a material or component that may convert a supplied form of energy into electrical energy. For example, a transducer may include a piezoelectric material, which may convert mechanical energy, such as from compression, vibration and/or other mechanical deformation, to electrical energy. Piezoelectric materials may include, but are not limited to, polymers such as PVDF, crystals such as quartz, or a Rochelle salt crystal, piezoelectric ceramics, such as a lead-zirconate-titanate (PZT) ceramic, and/or any other appropriate piezoelectric materials. In general, a piezoelectric material may be selected that may effectively and efficiently harness an available source of mechanical energy. In one embodiment, mechanical energy may be supplied by the bite force or mastication of a user.

A transducer may also utilize a pyroelectric material, which may generate electrical energy in response to a temperature change. For example, a pyroelectric material may absorb thermal energy from the environment, such as from the body heat of a user to generate electrical energy. The pyroelectric material may also be heated separately before use. Some pyroelectric materials may also generate electric energy in response to cooling. Pyroelectric materials may include, but are not limited to, polymers such as PVDF and polyvinyl fluoride (PVF), gallium nitride (GaN), lithium tantalate, and/or any other appropriate pyroelectric material. In general, a pyroelectric material may be selected that may effectively and efficiently harness an available source of temperature change, such as the difference between ambient temperature and the oral cavity of a user.

A transducer layer 60 may in general form an electric potential with a separation of positive charges 61 and negative charges 63 across sides 62, 66 in response to an external stimulus B, as shown in FIG. 3b. The material of the transducer layer 60 may be poled, such as shown in FIG. 3d with a section of a PVDF polymer chain, to form a positive side and a negative side. Poling may in general be accomplished by, for example, subjecting the material to a strong external electric field to properly align the molecules of the material.

In an exemplary embodiment, a transducer layer 60 may be included in a dental device, such as with the OLED stack 50 shown in FIG. 3c. In general, the transducer layer 60 may be polarized such that electric current may flow from one side 62 to the other side 66 by means of electric circuitry. The transducer layer 60 may, for example, transfer electric current from a side 62 to an anode 58 via a conductor 64. Current may then travel through a circuit, such as the OLED stack 50 in FIG. 3c, to the side 66 via cathode 52.

In general, the wavelength of the light may range from about 350 nm to about 700 nm. In an exemplary embodiment, the output is filtered to provide an efficient source of visible blue light in the 380-520 nm range. In one embodiment, light is filtered to be in the 400-505 nm range, or about 475 nm in one embodiment. In another embodiment, the light is blue light in the range of about 430 nm to about 510 nm, the peak being either about 455 nm or about 470 nm (blue light).

The intensity (energy density) of the light may range from about 1 mW/cm² to about 1000 mW/cm² or higher, or about 1 mW/cm² to about 800 mW/cm², or from about 1 mW/cm² to about 200 mW/cm², or from about 1 mW/cm² to about 120 mW/cm², or about 20 mW/cm². In another embodiment, the power density, or energy delivered to the teeth, is adjusted to a setting of between about 100 mW/cm² to about 160 mW/cm², or, from about 130 mW/cm² to about 150 mW/cm².

In some aspects, a dental device may be constructed by depositing or embedding at least one light source into a base material and forming the material into a desired shape. FIG. 4 illustrates a dental device 70 of base material 72 with a light source 80, which may, in regard to the figure, denote a region populated by a single light source, such as an OLED stack, or multiple light sources such discrete LEDs, multiple OLED stacks or other light sources. The base material 72 may be any of the above discussed materials, in particular materials that may easily have light source 80 affixed to or embedded in. In general, the base material 72 may be formed into a desired shape with light source 80 thereon or therein, such as, for example, a tray 70, as shown in FIG. 4, or a flexible strip 70′, as shown in FIG. 4a.

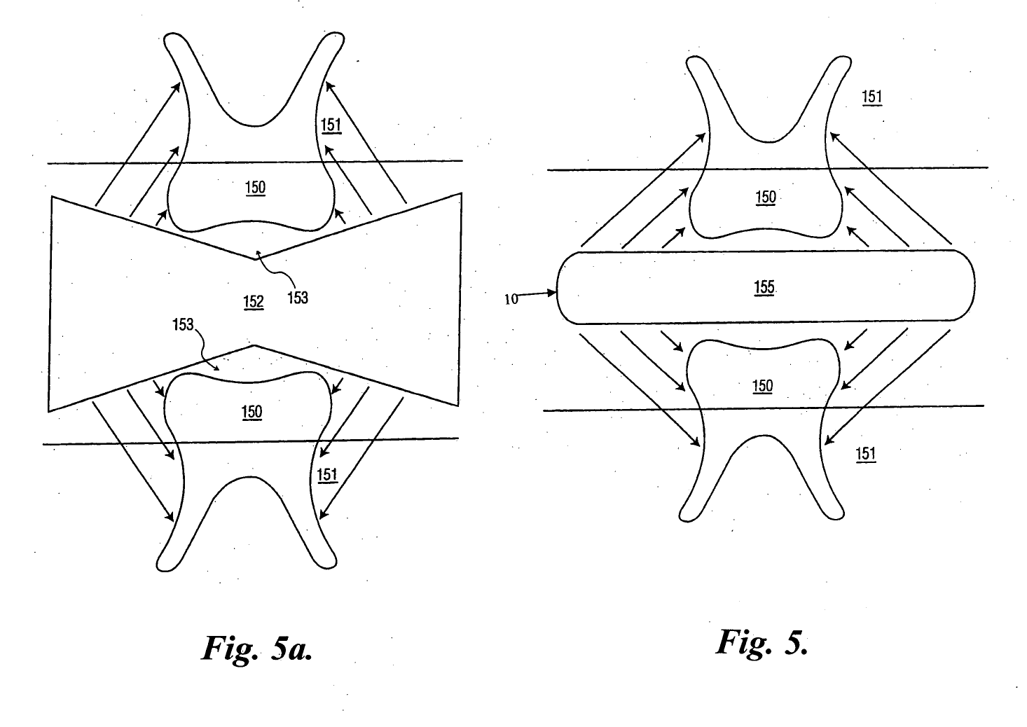

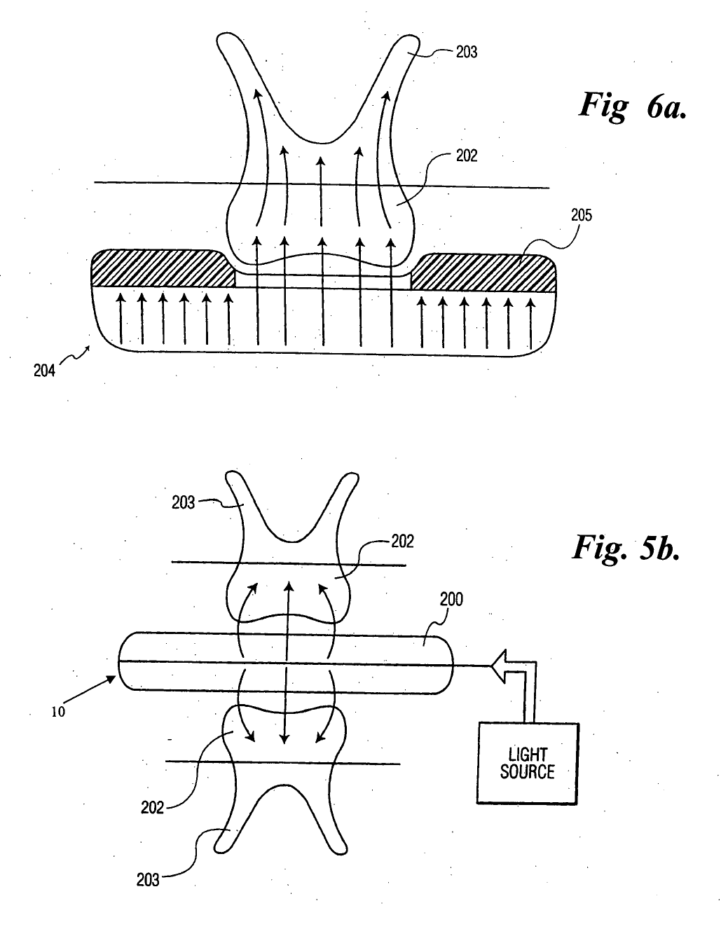

During use, a dental device 10 may, as depicted in FIG. 5, direct light towards the teeth 150 and gingiva 151 from a light emitting area 155. In other embodiments, as illustrated in FIGS. 5a and 5b, a dental device 10 may include bidirectional light emitting area 152 with channels 153. The incisal edges of the teeth 150 fit into the channels 153 and the illumination from the area 152 may be angled towards the lingual and buccal surfaces of the teeth 150 and gingiva 151.

The ability of the tooth itself to “pipe” (i.e., transmit light) certain wavelengths of light up to and in some cases under the gingiva, make for a unique means of illuminating oral structures that may not be directly illuminated by the device 10. By illuminating just the teeth, or illuminating the teeth with higher intensity light than the gingival tissue, the subgingival tissue may also gain therapeutic benefits due to the unique light transmitting properties of tooth enamel and dentin. This mechanism is illustrated in FIGS. 5b and 5c, although it may apply to all devices disclosed herein. As shown in FIG. 5b, device 10 may deliver light from the light emitting area 200 to significant portions of the teeth 202 and gums 203 (buccal and lingual sides). The light may then be transmitted bidirectionally. As shown in FIG. 5c, the light may also be piped through the teeth 202 into the gums 203.

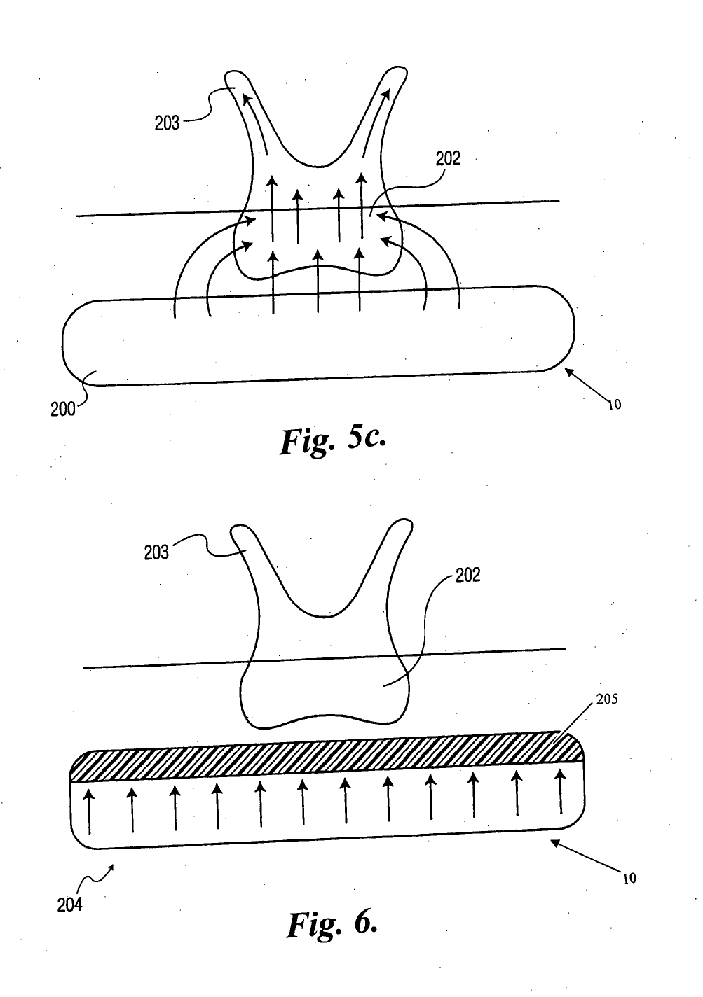

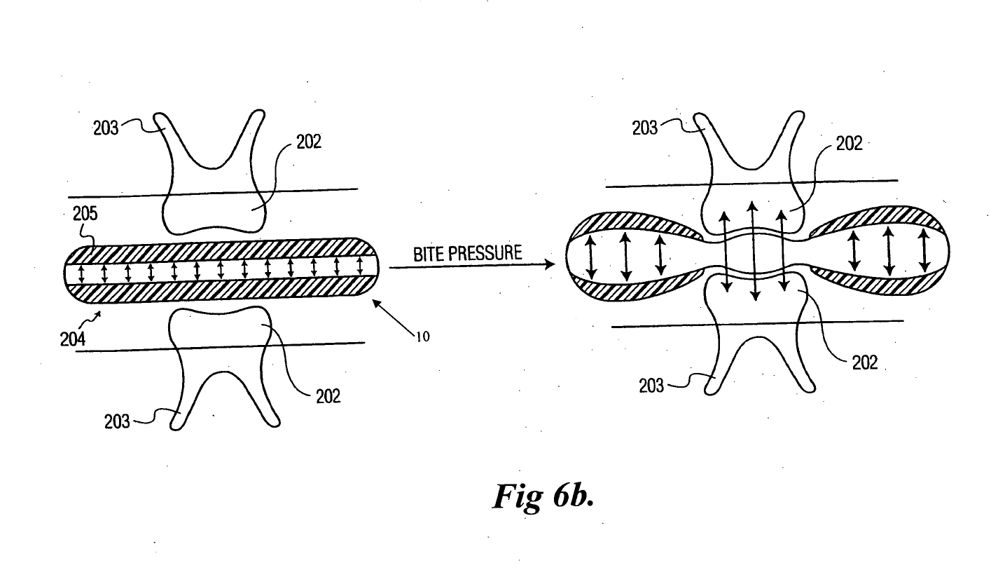

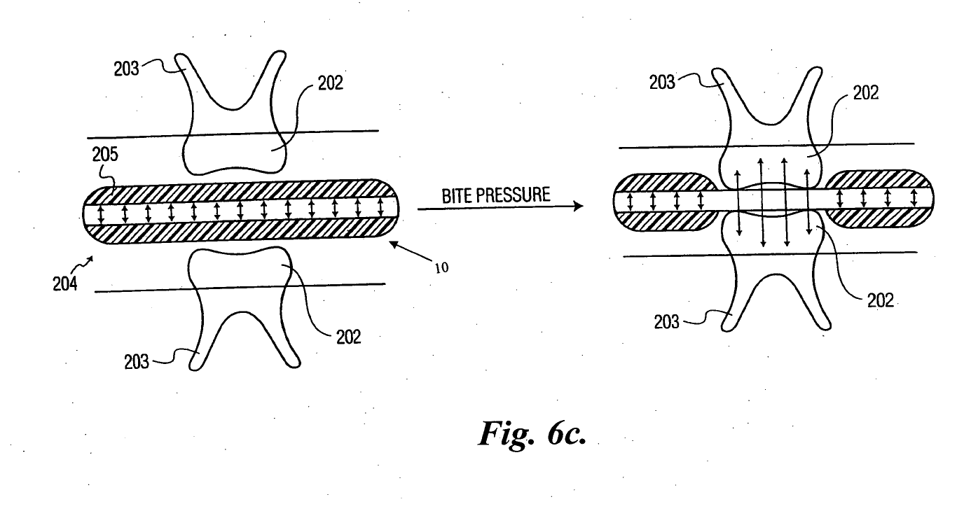

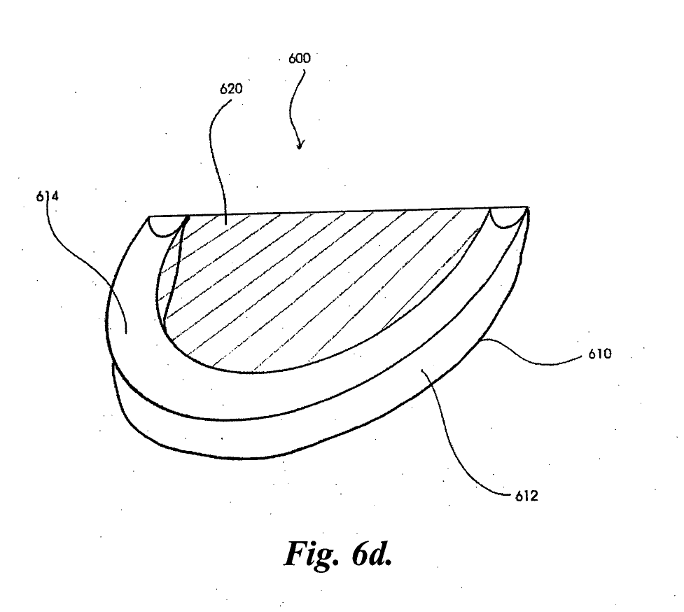

In another aspect, the device 10 may include a light gating layer 205 on light emitting layer 204, as shown in FIG. 6. The gating layer 205 may be opaque. The opaque gating layer 205 may be a flexible polymer or elastomer such as an ethylene vinyl acetate copolymer or styrene-butadiene-styrene block copolymer with dispersed light-blocking agents or fillers, such as titanium dioxide or zinc oxide. Alternatively, the opaque gating layer 205 may be a liquid or gel such as a silicone fluid with dispersed light blocking agents or fillers encased in a leak proof flexible outer casing that is integrally attached an underlying layer. The gating layer 205 may only allow light through sufficient pressure is exerted to thin the gating layer to render it transparent or translucent.

As shown in FIG. 6a, device 10 may include a light-emitting layer 204 covered by an opaque gating layer 205 that may be sufficiently flexible to allow the pressure exerted by the teeth biting down on the surface of gating layer 205 to thin or flatten it in order to increase its transparency. Whereas the gating layer 205 may be impermeable to light in its normal, uncompressed state (for instance, approximately 1-2 mm thick), when pressure is applied to the gating layer 205, it may thin out and allow for more light to be “gated” through the layer 205 (which when contacted by teeth under pressure may thin out to about, 0.1-0.2 mm or less). In one embodiment, at least a part of rigid inner light-emitting layer 204 may be covered with a flexible, opaque gating layer 205 that may come in contact with the teeth 202 and may allow light to pass through it when under sufficient pressure to cause thinning and subsequent light transmission. The opaque layer may also become more transparent under pressure. Other shapes and profiles are envisioned, such as shown in FIGS. 6b and 6c. Optionally, a contact switch may be included that triggers or completes an electrical circuit, such that only when a patient bites down on the illuminating plate does the light turn on and emit from the device. Further, the contact switch may be connected to a timer, which would only allow light to be emitted from the plate for a predetermined interval of time.

Rigid, for the purposes of this invention, means less flexible than the flexible gating opaque layer, if any, described above. The rigid light-emitting layer 204 may be of sufficient hardness and structural integrity to maintain its original shape until placed into the oral cavity. In general, and when provided with an inner light-emitting layer 204 and an outer, separate opaque gating layer 205, the inner layer 204 may be more rigid than the gating layer 205, which may allow for the compression of the gating layer 205 to affect the necessary thinning of the layer for gating the light, and the inner layer 204 may be rigid enough to resist said thinning pressure.

In one embodiment, the opague or blocking layer may also be part of the dental tray as shown in FIG. 6D, for example, wherein the portions adjacent the teeth may be configured to admit light of all wavelengths effective for whitening, while the portions adjacent the tissues may be configured to admit only light that is therapeutic. The channel 610 may be constructed of light conductive materials and may allow the delivery of therapeutic light to the teeth. The channel 610 may include an inner layer 614 that may be light conductive to allow the transmission of light to the teeth. The channel 610 may further include an outer layer 612 that may have different optical properties than the inner layer 614. The outer layer 612 may be adapted to control the passage of light to the soft tissues of the mouth surrounding the teeth by blocking, altering or otherwise affecting the light passing through the tray 600. The tray 600 may further include a plate or film 620 that may connect the edges of the channel 610. The plate or film 620 may have different optical properties than the inner layer 614 of the channel 610 and may be adapted to perform functions similar to the outer layer 612 of the channel 610, but instead acting on the roof or floor (including the tongue) of the mouth, depending on which set of teeth the tray 600 is used on. The components mentioned above may be in optical communication with each other such that light may enter the tray 600 at a single point and be conducted to all elements of the tray 600 internally. In some embodiments, the tray 600 may receive light from an external source. In other embodiments, the tray 600 may include chemiluminescent mixtures to internally produce light. In further embodiments, the tray 600 may include internal light sources such as LEDs.

In another embodiment, the outer layer 612 of the channel 600 may include louvers for directing light towards or away from any area of the oral cavity,

In a further embodiment, the dental tray 600 as shown above may be configured such that the portions adjacent the front or facial surface of the teeth may be configured to admit light of all wavelengths effective for whitening, while the portions adjacent the tissues and the backside or lingual surface of the teeth may be configured to admit only light that is therapeutic.

Any of these forms may also be used in conjunction with the liquid blocking material discussed above. Also, any of the bi-directional plate materials may also be used to form the trays.

In still another aspect, the dental device may be used in conjunction with chemical agents. The tray 10, such as shown in FIGS. 1, 1a, 2 or 2a, may also be configured to contain chemical or therapeutic agents that may be activated by the light to aid in the oral treatment. At the same time, non-light activatbale therapeutic agents including some vitamins and/or other dietary aids may also be administered. In this manner, multiple therapeutic actions may be administered at once to save time.

Light-activated chemical compositions may be utilized to enhance therapeutic effects and/or utilize light energy to produce a therapeutic effect. In one embodiment, a chemical agent that increases the susceptibility of oral microbes to light may be used. In another embodiment, a light-activated teeth whitening composition may be used. Teeth whitening compositions may include an oxidizing agent, such as hydrogen peroxide and/or carbamide peroxide, and a photoinitiator. Teeth whitening compositions may also include other agents such as flavorants, stabilizers, desensitizing agents, remineralizing agents, and/or any other appropriate agents.

Therapeutic effect as used herein may include exposing to a therapeutically effective amount of light to improve oral health; a therapeutically effective amount of both light and an oxidizing agent to improve oral health; a therapeutically effective amount of both light and at least one auxiliary chemical agent that increases the susceptibility of oral bacteria to light; or a therapeutically effective amount of light while simultaneously being subjected to an auxiliary or therapeutically effective physical or mechanical action. An “effective amount” or “therapeutically effective amount” refers to the amount of light and optional agent or action which is required to confer therapeutic effect on the treated subject.

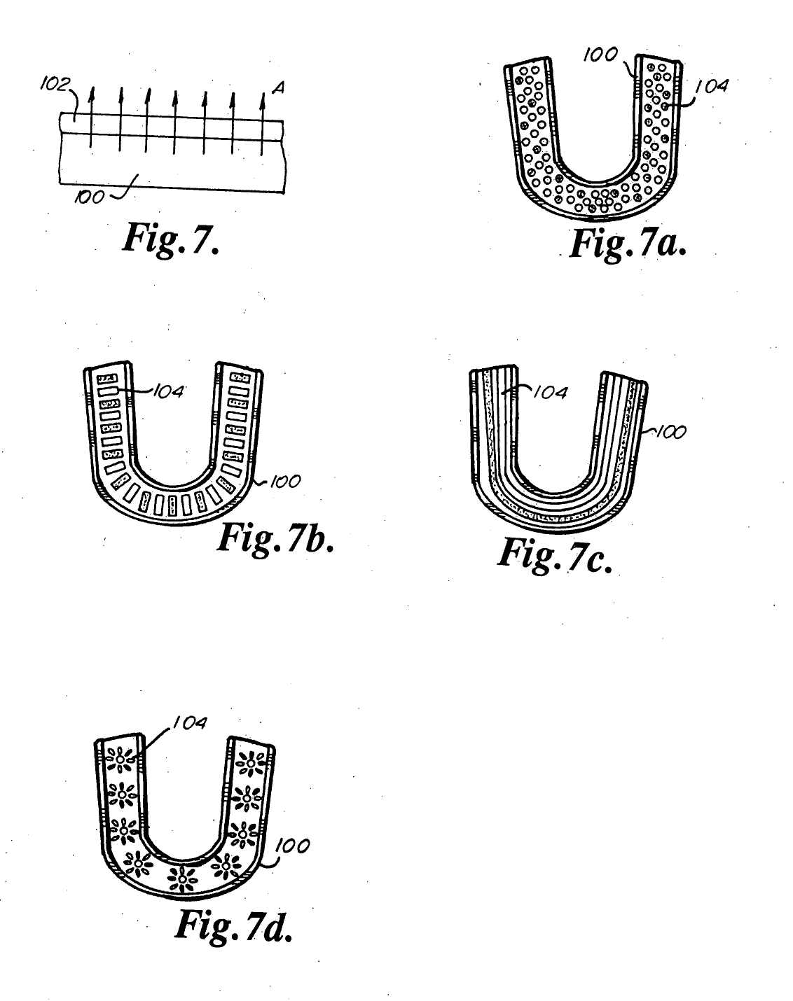

In some embodiments, a device 100 may include at least one coating 102 of a therapeutic chemical composition, as shown in FIG. 7. The coating 102 may be a composition that includes a water soluble carrier in which at least one chemical agent may be dispersed. The water soluble carrier may be, for example, a soluble polymeric material. Such materials include, but are not limited to, hydrophilic materials including polysaccharides such as carrageenan, chondroitin sulfate, glucosamine, pullulan, soluble cellulose derivatives such as hydroxypropyl cellulose and hydroxymethyl cellulose, polyacrylic acid, polyvinyl alcohol, polyethylene glycol (PEG), polyethylene oxide (PEO), ethylene oxide-propylene oxide co-polymer, polyvinylpyrrolidone (PVP) and/or any other appropriate material.

In an exemplary embodiment, the water soluble carrier included is pullulan. Pullulan is a soluble polysaccharide polymer derived from a fungal organism composed of triose sugar units. Pullulan coatings may be a self adherent, flexible and/or relatively high strength film that may resiliently remain on the applied surface(s) and that dissolves very quickly on contact with a wet or moist environment. They are also useful in encapsulating other materials, as pullulan has oxygen barrier properties and is thus further useful for preserving the encapsulated material(s).

The coating 102 may cover any desired portion of the device. In general, the coating 102 may cover at least a portion that may be in contact with the teeth or oral tissues when in use.

In some embodiments, the device may include coatings 104 disposed in patterns on its surface. The coatings 104 may be formed to give visual appeal to the user, such as by introducing particular patterns. Patterns may include, for example, stripes, as shown in FIGS. 7b, 7c, spots, as shown in FIG. 7a, checkerboards, floral designs, as shown in FIG. 7d, pictures, and/or any other appropriate pattern.

In one exemplary embodiment, the light energy may be provided by light emitting chemical materials and/or reactions. Components of a chemi-luminescent material may be kept separated prior to use, as noted above. For example, a set of coating stripes, spots or other shape may contain components of a light generating reaction, such as a chemi-luminescent composition. Upon placing inside the oral cavity, the coatings may dissolve due to oral cavity moisture and release the components of the composition to combine. For more effective use of such light generating compositions, the layers containing the components may be overcoated with a moisture permeable and chemical impermeable layer so that the light emitting chemicals may be contained even after the layers carrying the components are dissolved.

In another exemplary embodiment, multiple separated coatings may be used to contain therapeutic agents that may be kept separate prior to use. For example, a set of coating stripes, spots or other shape may contain parts of a remineralizing composition, such as an amorphous calcium phosphate (ACP) or amorphous strontium phosphate composition. One set of coatings may contain a calcium source, such as calcium nitrate, and another set of coatings may contain a phosphate source, such as sodium phosphate. The composition may then be formed when the coatings dissolve due to oral cavity moisture and release the components of the composition to combine.

In one embodiment, the dental device may be used for whitening and a one component whitening composition may be introduced to the tray already including separate sets of coatings of components of amorphous calcium or strontium phosphate.

Having described the present invention in reference to the embodiments mentioned above, it will be understood that any variations and equivalents are within the scope of the present invention.

1. A device for improving oral health, comprising:
a dental tray adapted for fitting completely inside an oral cavity, said tray comprising at least one channel; and
at least one light source disposed in said tray;
wherein at least a portion of said channel comprises a light transmissive material for transmitting light from said light source to the oral cavity.

2. The device of claim 1, wherein the light source emits a therapeutically effective amount of light in the wavelength range selected from the group consisting of about 350 nm to about 700 nm; about 380 nm to about 520 nm; about 400 nm to about 505 nm and about 430 nm to about 510 nm.

3. The device of claim 1 wherein said at least one light source is embedded in said tray.

4. The device of claim 1 wherein said at least one light source comprises organic or polymer light emitting diodes, light emitting chemicals or combinations thereof.

5. The device of claim 4 wherein said at least one light source comprises at least one layer of organic or polymer light emitting diodes, light emitting chemicals or combinations thereof.

6. The device of claim 1 further comprises a light gating layer.

7. The device of claim 6 wherein said gating layer is an opaque layer.

8. The device of claim 7 wherein said light transmissive layer is less flexible than the light gating layer.

9. The device of claim 6 wherein said light gating layer is a pressure-sensitive gate adapted for allowing light through a subject's teeth upon exertion of pressure.

10. The device of claim 7 wherein said opaque gating layer increases in transparency upon application of pressure.

11. The device of claim 1 further comprising a power source for powering the light source, said power source is disposed within said device.

12. The device of claim 5 wherein said light emitting chemicals comprises fluorescent, phosphorescent, or chemi-luminescent materials.

13. The device of claim 1 further comprising a chemical or therapeutic agent disposed in said channel.

14. The device of claim 13 wherein said chemical or therapeutic agent comprises a soluble polysaccharide polymer.

15. The device of claim 13 wherein said chemical or therapeutic agent comprises an oxidizing agent, a de-sensitizing agent, a remineralizing agent, an antimicrobial agent, a vitamin, or combinations thereof.

16. A device for improving oral health, comprising:
a dental tray comprising a light transmissive material adapted for fitting completely inside an oral cavity;
at least one light source disposed in said tray; and
at least one opaque gating formation disposed about said tray, said gating formation is pressure sensitive.

17. The device of claim 16 wherein said light source gating formation thins upon application of pressure.

18. The device of claim 16 wherein said gating formation increases in transparency upon application of pressure.

19. The device of claim 16 wherein said at least one light source comprises organic or polymer light emitting diodes, light emitting chemicals or combinations thereof.

20. A device for improving oral health, comprising:
a tray formed of a polymeric film material; and
coated on at least one surface of said film material is a soluble polysaccharide polymer in a pattern.

21. The device of claim 20 wherein said film material comprises a soluble polysaccharide polymer in an alternating pattern.

22. The device of claim 21 wherein each of said alternating pattern comprises at least one component of a chemical reaction, said chemicals react to generate light.

23. The device of claim 20 further comprising a therapeutic agent.

24. The device of claim 22 wherein said film material is over-coated with a layer of moisture permeable and light generating chemical impermeable material.
